(19) United States
(12) Patent Application Publication
(10) Pub. No.: US 2023/0319307 A1
(43) Pub. Date: Oct. 5, 2023

(54) VIDEO ENCODING AND DECODING METHOD AND APPARATUS USING SUBBLOCK BASED INTRA PREDICTION

(71) Applicants: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(72) Inventors: Byeung Woo Jeon, Seongnam-si (KR); Bum Yoon Kim, Yongin-si (KR); Jee Yoon Park, Seoul (KR); Seung Wook Park, Yongin-si (KR)

(73) Assignees: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(21) Appl. No.: 18/195,019

(22) Filed: May 9, 2023

Related U.S. Application Data
(63) Continuation of application No. PCT/KR2021/017256, filed on Nov. 23, 2021.

(30) Foreign Application Priority Data
Nov. 23, 2020 (KR) 10-2020-0157792
Nov. 23, 2021 (KR) 10-2021-0162006

(51) Int. Cl. H04N 19/593; H04N 19/176; H04N 19/44; H04N 19/184

(52) U.S. Cl. CPC H04N 19/593; H04N 19/176; H04N 19/184; H04N 19/44

(57) ABSTRACT

A video encoding/decoding method and an apparatus using intra prediction per subblock basis are provided. The video encoding/decoding method and apparatus modify the intra prediction mode of a current block in a direction suitable for a subpartitioned block by considering the shape of the subpartitioned block, the direction of subpartitioning, and the prediction direction of the current block. Based on the modified intra prediction mode of the current block, the video encoding/decoding method and apparatus generate an intra prediction mode of the subpartitioned block to perform intra prediction per subblock basis effectively.

### CROSS-REFERENCE TO RELATED APPLICATIONS

This application is a Continuation of International Application No. PCT/KR2021/017256 filed on Nov. 23, 2021, which claims priority to Korean Patent Application No. 10-2020-0157792 filed on Nov. 23, 2020, and Korean Patent Application No. 10-2021-0162006 filed on Nov. 23, 2021, the entire disclosures of each of which are incorporated herein by reference.

### TECHNICAL FIELD

The present disclosure relates to a video encoding/decoding method and an apparatus using intra prediction per subblock basis.

### BACKGROUND

The statements in this section merely provide background information related to the present disclosure and do not necessarily constitute prior art.

Since video data has a large amount of data compared to audio or still image data, video data requires a lot of hardware resources, including memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/AVC, High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In image (video) encoding, when an image is split on a per CU (Coding Unit) and encoded on a per CU, all pixels in a block to be encoded are intra predicted using one prediction mode. Since the distance between pixels and the reference pixels may become farther, a large amount of energy may remain in residual signals to be encoded. The problem of remaining energy in the residual signals may become more severe for a horizontally (or vertically) long rectangular block for which the distance between a pixel to be predicted and the reference pixel is long or when the size of the block is large. The block may be split further to solve the problem, but it leads to another problem of increasing the overhead for transmitting an intra prediction mode for each subdivided block.

Meanwhile, another solution is also at hand for addressing the problem of increasing overhead. The prior art performs prediction by splitting a block to be encoded one more time into evenly split smaller blocks to reduce the overhead while improving intra prediction efficiency but transmits only a single prediction mode on a per original block before subpartitioning and applies the single prediction mode commonly for subpartitioned small blocks. The background described above is called Intra Sub-Partition (ISP) technique.

When ISP is applied for intra prediction of a current block, the video encoding and decoding apparatus may signal one intra prediction mode while predicting subpartitioned blocks using reference pixel values close to the respective subpartitioned blocks. On the other hand, a problem arises when the ISP technique is applied in that the intra prediction mode applied to the current block may not be the optimal mode for subpartitioned blocks. Therefore, a method for effectively coding the prediction mode of a subblock needs to be considered in terms of coding efficiency.

### SUMMARY

The present disclosure in some embodiments seeks to provide a video encoding/decoding method and an apparatus for modifying the intra prediction mode of a current block in a direction suitable for a subpartitioned block by considering the shape of the subpartitioned block, the direction of subpartitioning, and the prediction direction of the current block. Based on the modified intra prediction mode of the current block, the video encoding/decoding method and apparatus generate an intra prediction mode of the subpartitioned block to perform intra prediction per subblock basis effectively.

At least one aspect of the present disclosure provides an intra prediction method for generating modified prediction modes of subblocks performed by a video decoding apparatus. The method comprises decoding an intra prediction mode of a current block, information of the current block, and subblock information from a bitstream. The subblock information provides information related to subblocks obtained by partitioning the current block. The method also comprises selecting a method for modifying a prediction mode based on the information of the current block and the subblock information. The method also comprises generating the modified prediction modes by modifying the intra prediction mode of the current block based on the method for modifying the prediction mode.

Another aspect of the present disclosure provides a video decoding apparatus generating modified prediction modes of subblocks. The apparatus comprises an entropy decoder configured to decode an intra prediction mode of a current block, information of the current block, and subblock information from a bitstream. The subblock information provides information related to subblocks obtained by partitioning the current block. The apparatus also comprises an intra predictor configured to select a method for modifying a prediction mode based on the information of the current block and the subblock information and generating the modified prediction modes by modifying the intra prediction mode of the current block based on the method for modifying the prediction mode.

Yet another aspect of the present disclosure provides an intra prediction method for generating modified prediction modes of subblocks performed by a video encoding apparatus. The method comprises obtaining an intra prediction mode of a current block, information of the current block, and subblock information. The subblock information provides information related to subblocks obtained by partitioning the current block. The method also comprises selecting a method for modifying a prediction mode based on the information of the current block and the subblock information. The method also comprises generating the modified prediction modes by modifying the intra prediction mode of the current block based on the method for modifying the prediction mode.

As described above, the present embodiment provides a video encoding/decoding method and an apparatus for modifying the intra prediction mode of a current block in a direction suitable for a subpartitioned block by considering the shape of the subpartitioned block, the direction of subpartitioning, and the prediction direction of the current block. Based on the modified intra prediction mode of the current block, the video encoding/decoding method and apparatus generate an intra prediction mode of the subpartitioned block to improve coding efficiency of the intra prediction.

Also, the present embodiment provides a video encoding/decoding method and an apparatus for modifying the intra prediction mode of a current block in a direction suitable for a subpartitioned block by considering the shape of the subpartitioned block, the direction of subpartitioning, and the prediction direction of the current block. Based on the modified intra prediction mode of the current block, the video encoding/decoding method and apparatus generate an intra prediction mode of the subpartitioned block, to improve image quality of a decoded image.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 shows a current block and subpartitioned subblocks.

FIG. 7 illustrates a problem of intra sub-partition (ISP) technique due to the application of wide angel intra prediction (WAIP) technique.

FIG. 8 illustrates of subblocks with various shapes according to one embodiment of the present disclosure.

FIG. 9 conceptually illustrates a prediction mode modifier according to one embodiment of the present disclosure.

FIGS. 10A and 10B illustrates embodiments in which a partitioning direction of a subblock is used as the information of the subblock.

FIG. 11 conceptually illustrates a prediction mode modifier according to another embodiment of the present disclosure.

FIGS. 12A-12E illustrate methods for selecting a representative block according to one embodiment of the present disclosure.

FIG. 13 illustrates selecting a representative block and modifying a prediction mode according to one embodiment of the present disclosure.

FIG. 14 illustrates a condition on a specific size of representative block according to one embodiment of the present disclosure.

FIGS. 15A and 15B illustrate modifying a prediction mode of a subblock based on the size of a representative block according to one embodiment of the present disclosure.

FIGS. 16A and 16B illustrate a condition for modifying a prediction mode of a subblock based on the shape of a representative block according to one embodiment of the present disclosure.

FIG. 17 illustrates modifying a prediction mode of a subblock based on the shape of a representative block according to one embodiment of the present disclosure.

FIG. 18 illustrates modifying a prediction mode of a subblock based on the position of a representative block according to one embodiment of the present disclosure.

FIG. 19 illustrates modifying a prediction mode of a subblock based on a prediction direction according to one embodiment of the present disclosure.

FIG. 20 conceptually illustrates a prediction mode modifier according to another embodiment of the present disclosure.

FIG. 21 illustrates modifying an intra prediction mode for each subblock according to one embodiment of the present disclosure.

FIG. 22 illustrates modifying an intra prediction mode for each subblock based on the size of a representative block according to one embodiment of the present disclosure.

FIG. 23 illustrates the order of encoding (or decoding) subblocks within a current block.

FIG. 24 illustrates the order of modifying prediction modes of subblocks according to one embodiment of the present disclosure.

FIG. 25 illustrates modifying a prediction mode of a subblock based on a preset pattern according to one embodiment of the present disclosure.

FIG. 26 conceptually illustrates a prediction mode modifier according to yet another embodiment of the present disclosure.

FIG. 27 illustrates a mode modification flag according to yet another embodiment of the present disclosure.

FIG. 28 is a flow diagram illustrating a method of modifying prediction modes of subblocks performed by a video decoding apparatus according to one embodiment of the present disclosure.

FIG. 29 is a flow diagram illustrating a method for modifying prediction modes of subblocks performed by a video decoding apparatus according to another embodiment of the present disclosure.

FIG. 30 is a flow diagram illustrating a method for modifying prediction modes of subblocks performed by a video encoding apparatus according to one embodiment of the present disclosure.

FIG. 31 is a flow diagram illustrating a method for modifying prediction modes of subblocks performed by a video encoding apparatus according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, a detailed description of related known components and functions when considered to obscure the subject of the present disclosure has been omitted for the purpose of clarity and for brevity.

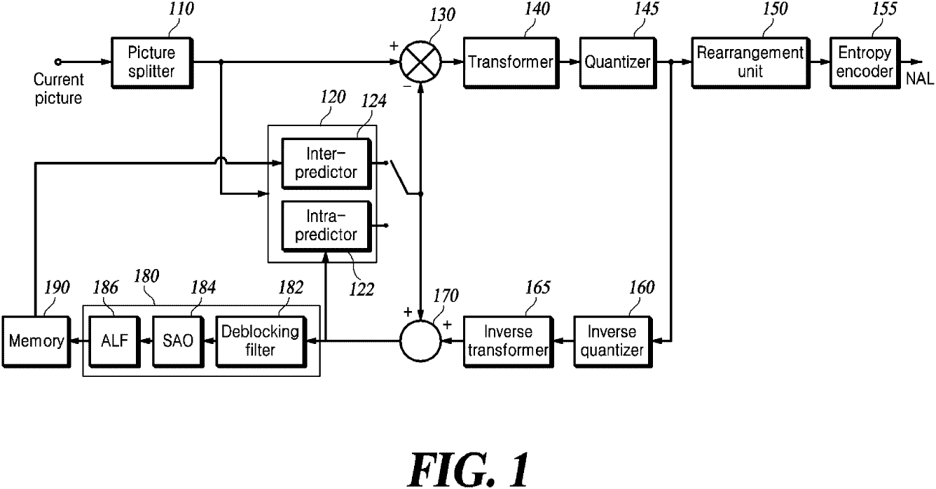

FIG. 1 is a block diagram for a video encoding apparatus, which may implement technologies of the present disclosure. Hereinafter, referring to illustration of FIG. 1, the video encoding apparatus and sub-components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as the software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each CU is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of CTU. Information on the size of the CTU (CTU size) is encoded as the syntax of the SPS or the PPS and delivered to a video decoding apparatus.

The picture splitter 110 splits each picture constituting the video into a plurality of CTUs having a predetermined size and then recursively splits the CTU by using a tree structure. A leaf node in the tree structure becomes the CU, which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a BTTT is added to the tree structures to be referred to as a multiple-type tree (MTT).

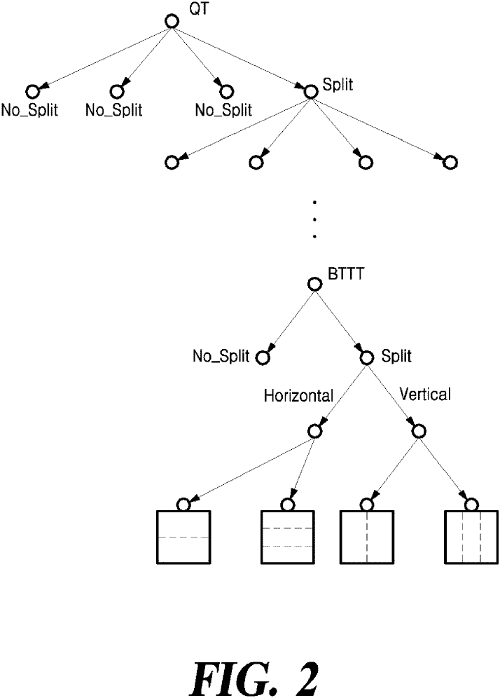

FIG. 2 is a diagram for describing a method for splitting a block by using a QTBTTT structure.

As illustrated in FIG. 2, the CTU may first split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., in a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks of a form of being asymmetrical to each other may be additionally present. The asymmetrical form may include a form in which the block of the corresponding node split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

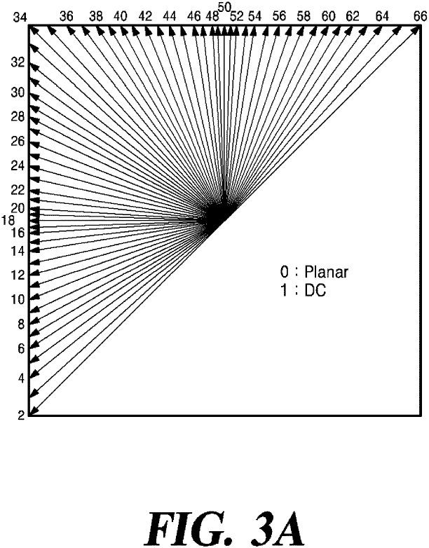

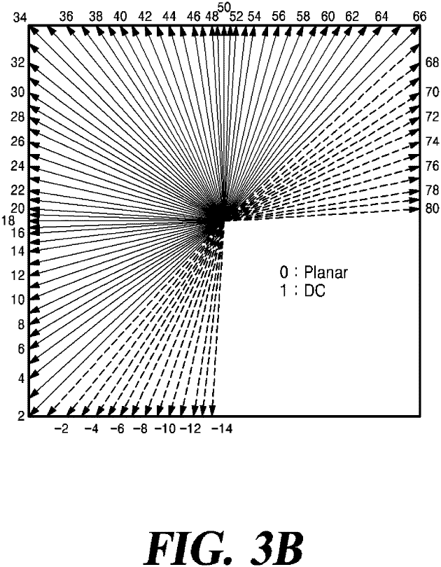

The intra predictor 122 predicts pixels in the current block by using pixels (reference pixels) positioned on a neighboring of the current block in the current picture including the current block. There is a plurality of intra prediction modes according to the prediction direction. For example, as illustrated in FIG. 3A, the plurality of intra prediction modes may include 2 non-directional modes including a planar mode and a DC mode and may include 65 directional modes. A neighboring pixel and an arithmetic equation to be used are defined differently according to each prediction mode.

For efficient directional prediction for the current block having the rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than -135 degrees are usable.

The intra predictor 122 may determine an intra prediction to be used for encoding the current block. In some examples, the intra predictor 122 may encode the current block by using multiple intra prediction modes and also select an appropriate intra prediction mode to be used from tested modes. For example, the intra predictor 122 may calculate rate-distortion values by using a rate-distortion analysis for multiple tested intra prediction modes and also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current bock in the current picture and the prediction block in the reference picture. In general, motion estimation is performed for a luma component, and a motion vector calculated based on the luma component is used for both the luma component and a chroma component. Motion information including information the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of the bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and information on two motion vectors is delivered to the entropy encoder 155. Here, reference picture list 0 may be constituted by pictures before the current picture in a display order among pre-restored pictures, and reference picture list 1 may be constituted by pictures after the current picture in the display order among the pre-restored pictures. However, although not particularly limited thereto, the pre-restored pictures after the current picture in the display order may be additionally included in reference picture list 0. Inversely, the pre-restored pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

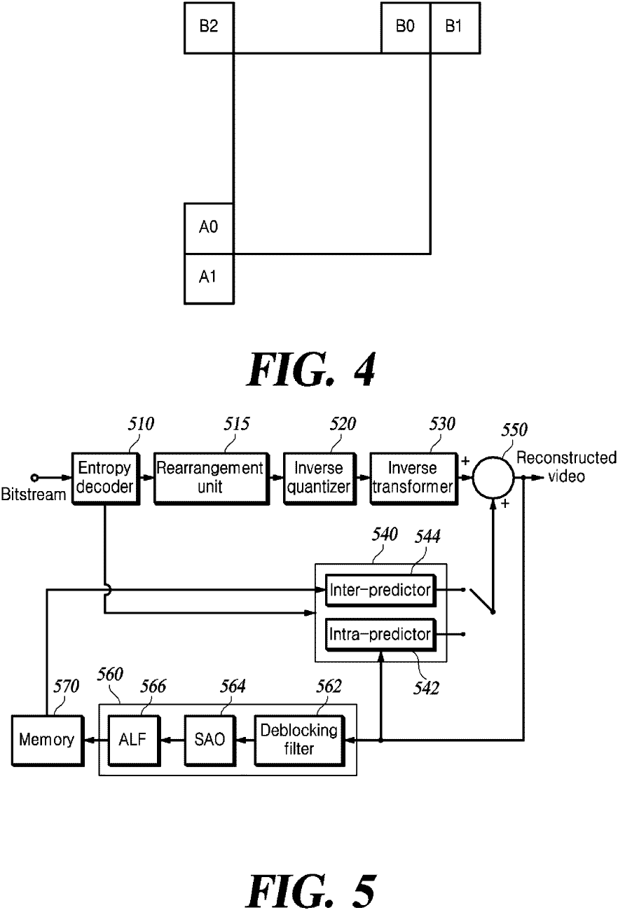

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

The merge skip mode is a special case of the merge mode. After quantization, when all transform coefficients for entropy encoding are close to zero, only the neighboring block selection information is transmitted without transmitting a residual signal. By using the merge skip mode, it is possible to achieve a relatively high encoding efficiency for images with slight motion, still images, screen content images, and the like.

Hereafter, the merge mode and the merge skip mode are collectively called the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms a residual signal in a residual block having pixel values of a spatial domain into a transform coefficient of a frequency domain. The transformer 140 may transform residual signals in the residual block by using a total size of the residual block as a transform unit or also split the residual block into a plurality of subblocks and perform the transform by using the subblock as the transform unit. Alternatively, the residual block is divided into two subblocks, which are a transform area and a non-transform area to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to transform coefficients quantized arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, etc.

Further, the entropy encoder 155 encodes information such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to restore the residual block.

The adder 170 adds the restored residual block and the prediction block generated by the predictor 120 to restore the current block. Pixels in the restored current block are used as reference pixels when intra-predicting a next-order block.

The loop filter unit 180 performs filtering for the restored pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the restored blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating a difference between the restored pixel and an original pixel, which occurs due to lossy coding. The SAO filter 184 applies an offset as a CTU unit to enhance a subjective image quality and encoding efficiency. Contrary to this, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The restored block filtered through the deblocking filter 182, the SAO filter 184, and the ALF 186 is stored in the memory 190. When all blocks in one picture are restored, the restored picture may be used as a reference picture for inter predicting a block within a picture to be encoded afterwards.

FIG. 5 is a functional block diagram for a video decoding apparatus, which may implement the technologies of the present disclosure. Hereinafter, referring to FIG. 5, the video decoding apparatus and sub-components of the apparatus are described.

The video decoding apparatus may be configured to include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU is extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (MTT_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT being further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information, and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to restore the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include the intra predictor 542 and the inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 restores the current block by adding the residual block output from the inverse transformer 530 and the prediction block output from the inter predictor 544 or the intra predictor 542. Pixels within the restored current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the restored blocks in order to remove the blocking artifact, which occurs due to block unit decoding. The SAO filter 564 and the ALF 566 perform additional filtering for the restored block after the deblocking filtering in order to compensate a difference between the restored pixel and an original pixel, which occurs due to lossy coding. The filter coefficient of the ALF is determined by using information on a filter coefficient decoded from the bitstream.

The restored block filtered through the deblocking filter 562, the SAO filter 564, and the ALF 566 is stored in the memory 570. When all blocks in one picture are restored, the restored picture may be used as a reference picture for inter predicting a block within a picture to be encoded afterwards.

The present embodiment relates to encoding and decoding of an image (video) described above. More specifically, the present embodiment provides a video encoding/decoding method and an apparatus for modifying the intra prediction mode of a current block in a direction suitable for a subpartitioned block by considering the shape of the subpartitioned block, the direction of subpartitioning, and the prediction direction of the current block. Based on the modified intra prediction mode of the current block, the video encoding/decoding method and apparatus generate an intra prediction mode of the subpartitioned block to perform intra prediction per subpartitioned block basis efficiently.

In the following description, the aspect ratio of a block is defined as a value obtained by dividing the horizontal length of a block by the vertical length, i.e., the ratio between the horizontal length and the vertical length. In general, the shape of a current block may be different from the shape of a subdivided block may be different. The aspect ratio of the block may quantify the shape of a block. In the following description, when the shapes of two blocks are the same, it indicates that the aspect ratios of the two blocks are also the same. Also, similarity in the shapes of two blocks indicates similar aspect ratios between the two blocks.

### I. Intra Prediction and Intra Sub-Partition (ISP)

In the VVC technology, an intra prediction mode of a luma block has fine-divided directional modes (i.e., 14 to 80) in addition to the non-directional mode (i.e., Planar and DC), as illustrated in FIGS. 3A and 3B. Based on the prediction mode, there are several techniques available to improve the coding efficiency of intra prediction. After subpartitioning a current block into small blocks of the same size, the ISP technique shares an intra prediction mode among all subblocks. However, the ISP technique may apply a transform to each subblock. Here, subpartitioning of a block may be performed in a horizontal or vertical direction.

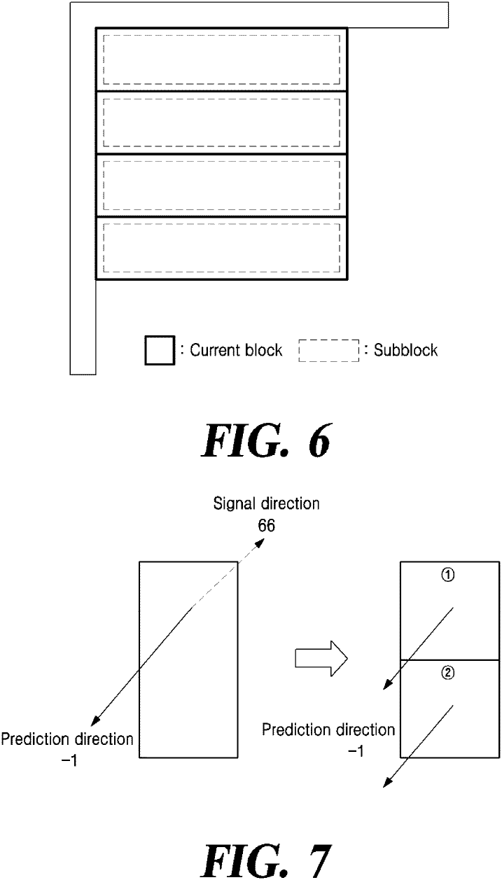

In the following description, as shown in FIG. 6, a large block before being subpartitioned is referred to as a current block, and each subpartitioned small block is referred to as a subblock.

The ISP technique operates as follows.

The video encoding apparatus signals intra_subpartitions_mode_flag indicating whether ISP is applied and intra_subpartitions_split_flag indicating a subpartitioning method to the video decoding apparatus. Splitting types for subpartitions, IntraSubPartitionsSplitType, according to intra_subpartitions_mode_flag and intra_subpartitions_split_flag are shows in Table 1.

TABLE 1

| IntraSubPartitionsSplitType | Name of IntraSubPartitionsSplitType |
|---|---|
| 0 | ISP_NO_SPLIT |
| 1 | ISP_HOR_SPLIT |
| 2 | ISP_VER_SPLIT |

The ISP technique sets the splitting type IntraSubPartitionsSplitType as follows.

When intra_subpartitions_mode_flag is 0, IntraSubPartitionsSplitType is set to 0, and subblock splitting is not performed. In other words, ISP is not applied.

If intra_subpartitions_mode_flag is not 0, ISP is applied. Here, IntraSubPartitionsSplitType is set to a value of 1 + intra_subpartitions_split_flag, and subblock splitting is performed according to the splitting type. If IntraSubPartitionsSplitType = 1, horizontal subblock splitting (ISP_HOR_SPLIT) is performed, and if IntraSubPartitionsSplitType = 2, subblock splitting is performed in the vertical direction (ISP_VER_SPLIT). In other words, intra_subpartitions_split_flag may indicate the direction of subblock splitting.

For example, when an ISP mode in which a block is subpartitioned in the horizontal direction is applied to the current block, IntraSubPartitionsSplitType is 1, intra_subpartitions_mode_flag is 1, and intra_subpartitions_split_flag is 0.

In the following description, intra_subpartitions_mode_flag is called a subblock splitting application flag, intra_subpartitions_split_flag is called a subblock splitting direction flag, and IntraSubPartitionsSplitType is called a subblock splitting type.

Also, ISP_HOR_SPLIT is used interchangeably with horizontal splitting, and ISP_VER_SPLIT is used interchangeably with vertical splitting.

When a current block is split horizontally or vertically, ISP application may be limited according to the current block’s size during splitting to prevent too small blocks from being split. In other words, when the current block size is 4×4, ISP is not applied. A block with a size of 4×8 or 8×4 may be split into two subblocks of the same shape and size, which is called Half_Split. Blocks of other sizes may be split into four subblocks of the same shape and size, which is called Quarter_Split.

The video encoding apparatus sequentially encodes each subblock. Here, each subblock shares the same intra prediction information. In intra prediction for encoding each subblock, the video encoding apparatus may increase compression efficiency by using reconstructed pixels in a previously encoded subblock as predicted pixel values of a subsequent subblock.

However, as described above, the existing method of splitting one block into a plurality of subblocks but sharing one prediction mode among the subblocks exhibits an efficiency issue in some respects. Although an intra prediction direction applied to a current block may not be the optimal prediction direction in a subpartitioned block, the conventional ISP technique presents a problem in effectively addressing this phenomenon. This problem becomes more pronounced when the wide-angle intra prediction (WAIP) technique is used, in which a prediction direction is determined by considering the aspect ratio of a block.

For example, as shown in FIG. 7, an intra prediction case is considered, in which a current block is a vertically long rectangular block, and the prediction mode 66 is signaled. At this time, the video encoding apparatus determines the prediction mode used for actual encoding as a direction of -1 according to the application of the WAIP technique. In other words, the prediction mode used for actual encoding is modified to -1 indicated as the prediction direction in the example of FIG. 7 as 67 is subtracted from the prediction mode 66 indicated as a signal direction in the example of FIG. 7. As shown in the example on the right side of FIG. 7, when the current block is subpartitioned, the video encoding apparatus performs intra prediction on all subblocks in the direction of -1. Therefore, in sequentially encoding subblocks, there may be a potential technical problem that the video encoding apparatus is unable to use reconstructed pixels in subblock ① as predicted pixel values for encoding subblock ②.

In the following description, various embodiments are disclosed to solve the technical problem above.

Meanwhile, the intra predictor 122 of the video encoding apparatus and the intra predictor 542 of the video decoding apparatus may perform the following embodiments. In the following description, to avoid repeated descriptions, the present embodiment is described from the perspective of the intra predictor 542 within the video decoding apparatus.

### II. Subblocks of Various Shapes and Sizes

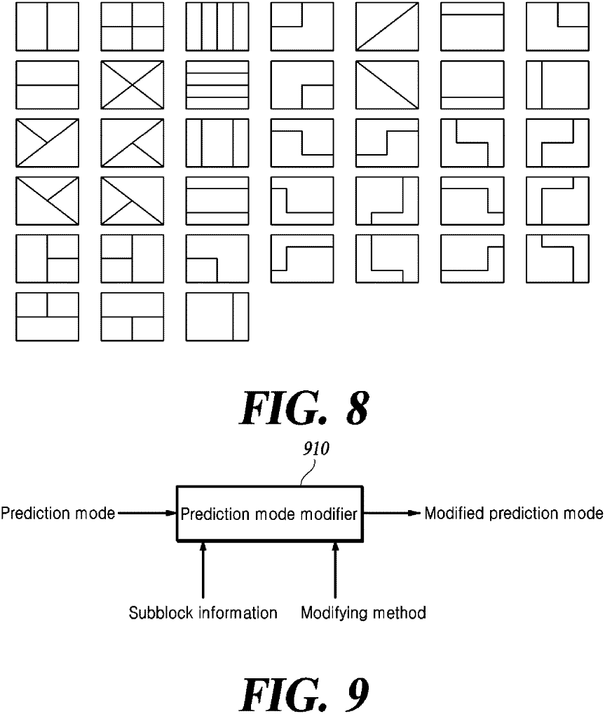

The present embodiment may solve the technical problem above by providing subblocks with more diverse shapes. In the prior art, when a block is subpartitioned, the block is partitioned only in a fixed horizontal or vertical direction. Meanwhile, in the present embodiment, a range of subpartitioning shapes may be used to comprehensively accommodate various cases, as shown in FIG. 8. In the following description, information related to the example of FIG. 8 is referred to as subpartitioning information.

Meanwhile, FIG. 3B illustrates intra prediction modes for intra prediction, but it should be noted that there are also other prediction modes.

### III. Modification of Intra Prediction Mode Based on Subblocks

In the present embodiment, an intra predictor 542 within the video decoding apparatus may modify the intra prediction mode based on subblocks obtained from subpartitioning of a current block.

FIG. 9 conceptually illustrates a prediction mode modifier according to one embodiment of the present disclosure.

The prediction mode modifier 910 according to the present embodiment modifies the prediction mode of a current block using subblock information and a modifying method to generate a modified prediction mode for intra prediction of subblocks. The prediction mode modifier 910 may be included in the intra predictor 542 within the video decoding apparatus. The intra predictor 542 may perform intra prediction of subblocks using the modified prediction mode.

The subblock information may include all or part of the size, width, height, aspect ratio, and splitting direction of a subblock, and the number of subblocks. In this embodiment, subblocks have a uniform shape.

The prediction mode modifier 910 may use the information of a current block in addition to the intra prediction mode of the current block. Here, information on the current block may include all or part of the size, width, height, and aspect ratio of the current block.

Various implementations of the present embodiment may be possible according to subblock information, a modifying method, and a target application. In the following description, various embodiments are described. For the convenience of explanation, it is assumed that the current block is square.

In the following description, an embodiment in which the prediction mode modifier 910 uses the aspect ratio of a subblock as the subblock information is described. As described above, the aspect ratio of a current block and the aspect ratio of a subblock of the current block may differ. Therefore, unlike existing methods applied per on a per current block before subpartitioned, the prediction mode modifier 910 applies block aspect ratio-based techniques (e.g., WAIP) per subblock basis and modifies the prediction mode of a subblock. Thus, the coding efficiency may be improved compared to the existing methods.

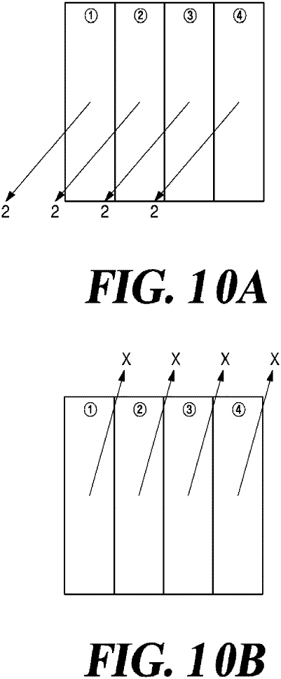

For example, consider a case in which the prediction mode of a current block is 66, and the current block is subpartitioned into subblocks ①, ②, ③, and ④ with an aspect ratio of 1:4, as shown in the examples of FIGS. 10A and 10B. In this case, prediction mode 66 of the current block is inefficient in intra prediction of subblocks. Accordingly, the intra prediction mode may be modified to prevent such inefficient prediction. For example, if a subblock is horizontally long, the prediction mode modifier 910 may modify the intra prediction mode to one of the prediction modes belonging to a vertical group. If a subblock is vertically long, the prediction mode modifier 910 may modify the intra prediction mode to one of the prediction modes belonging to a horizontal group. As described above, the prediction mode modifier 910 may improve coding efficiency by modifying an intra prediction mode based on subblocks.

Here, the horizontal group represents a set of prediction modes less than or equal to prediction mode 34 corresponding to the upper-left diagonal in the example of FIG. 3B, and the vertical group represents a set of prediction modes greater than prediction mode 34.

The prediction mode modifier 910 may modify the intra prediction mode by comparing the aspect ratio of a subblock with a preset threshold. For example, if the aspect ratio is greater than a specific ratio (i.e., when the block is significantly long horizontally (or vertically)) or small (i.e., when the block is not quite long horizontally (or vertically)), the prediction mode modifier 910 may modify the intra prediction mode.

Meanwhile, the prediction mode modifier 910 may use a method for modifying a prediction mode by selecting one from among the methods below.

As shown in FIG. 10A, the prediction mode modifier 910 may generate a modified prediction mode by rotating a prediction mode by a specific angle S. Here, the angle S may be 0, 45, 90, 135, 180, 225, 270, and 325 degrees, among others depending on the implementation. FIG. 10A shows a case where S is 180 degrees.

Alternatively, the prediction mode modifier 910 may set the modified prediction mode to a specific mode X, as shown in FIG. 10B. The specific mode X may be one of the prediction modes grouped according to a predetermined criterion or may be a predetermined mode.

Here, the predetermined criterion for grouping prediction modes may be one of a vertical group, a horizontal group, a diagonal group, a diagonal direction of the current block, a diagonal direction of a subblock, a directional mode group, a non-directional mode group, a prediction mode group calculated from machine learning, or a combination of some of the above.

Also, the predetermined mode may be specified as one of the Planar mode, the DC mode, a diagonal directional mode of a subblock, a diagonal directional mode of a current block, a mode calculated by machine learning, a vertical mode, a horizontal mode, or a diagonal direction mode.

Here, the diagonal represents an top right directional diagonal of a block, and the diagonal group represents a set of directional modes corresponding to the top right directional diagonals of a plurality of blocks having different aspect ratios. For example, the diagonal directional mode may be 66, which is the right top directional mode in the example of FIG. 3B.

In the following description, an embodiment in which the prediction mode modifier 910 uses the partitioning direction of a subblock as information on the subblock is described.

The prediction mode modifier 910 may select a prediction direction advantageous for intra prediction according to the subpartitioning direction. As shown in FIG. 10A, when the subpartitioning is performed in the vertical direction and the prediction mode in direction 2 is used, coding efficiency may be improved compared to the prediction mode in direction 66. This feature is obtained due to the availability of reconstructed reference pixels to be used for prediction. Therefore, according to the present embodiment, the prediction mode modifier 910 may modify the prediction mode according to the subpartitioning direction. In other words, the prediction mode modifier 910 may use different modifying methods for the respective cases where the subpartitioning is performed in vertical and horizontal directions. For example, when the subpartitioning is performed vertically, the prediction mode modifier 910 modifies the prediction mode to a mode corresponding to the horizontal group. When the subpartitioning is performed horizontally, the prediction mode modifier 910 modifies the prediction mode to a mode corresponding to the vertical group. Here, the prediction mode modifier 910 may use the method for modifying the prediction mode as described above.

The above implementation assumes that subblocks have uniform shapes. In another embodiment, as illustrated in FIG. 8, when subblock uniformity is not guaranteed, an intra prediction mode may be modified with reference to a representative block among subblocks.

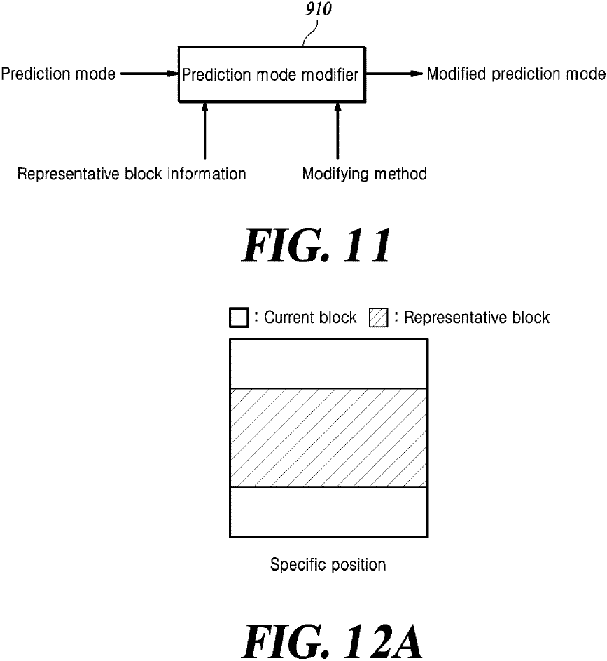

FIG. 11 conceptually illustrates a prediction mode modifier according to another embodiment of the present disclosure.

The prediction mode modifier 910 according to another embodiment modifies the prediction mode of a current block using the representative block information and the modifying method to generate a modified prediction mode for intra prediction of subblocks. Here, it is possible to use various subpartitioning structures, as shown in FIG. 8. In particular, the present embodiment may be applied even when the subblocks have different shapes.

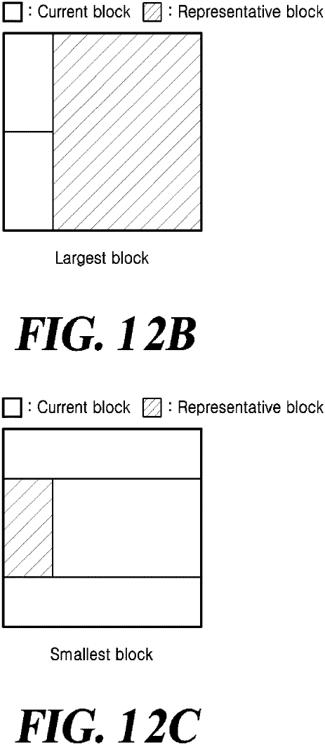

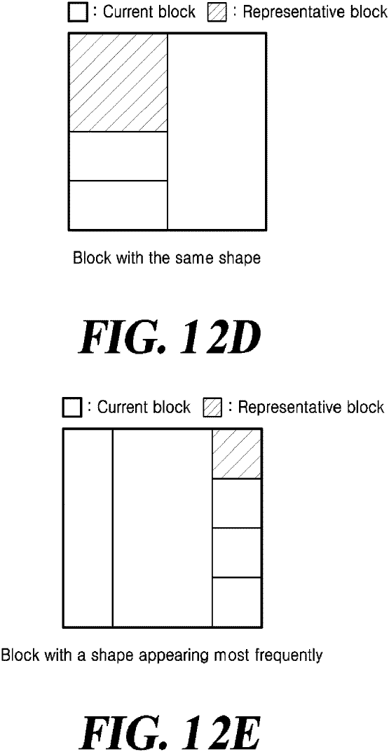

Meanwhile, the representative block may be selected according to at least one of the examples in FIGS. 12A-12E.

As shown in FIG. 12A, a subblock at a specific position within the current block may be selected as a representative block. Here, the representative block may be positioned at various points, including the center, left, right, top, bottom, top left, bottom right, and edge.

As shown in FIG. 12B, the largest subblock within a current block may be selected as a representative block.

As shown in FIG. 12C, the smallest subblock within a current block may be selected as a representative block.

As shown in FIG. 12D, a subblock having the same shape as a current block may be selected as a representative block. Depending on the application, it may be implemented in a modified form so that the subblock has the most similar shape to the current block is selected as a representative block.

As shown in FIG. 12E, a subblock with a shape appearing most frequently among subblocks may be selected as a representative block. In other words, a subblock with a shape that occurs most frequently is selected as a representative block among subpartitioned subblocks. For example, when a current block is subpartitioned into six subblocks having sizes of 4×16, 8 × 16, 4 × 4, 4 × 4, 4 × 4, and 4 × 4, a subblock having the size of the most frequently occurring subblock size, 4 × 4, is selected as a representative block.

Meanwhile, a representative block may be selected by the video encoding apparatus in terms of optimization of bit rate distortion. After selecting a representative block using representative block selection methods based on the subpartitioning information, the video encoding apparatus may transmit the representative block information to the video decoding apparatus.

The representative block information may describe the characteristics of a representative block selected from partitioned subblocks, including at least one of the representative block’s position, size, width, height, shape (or aspect ratio), or prediction mode. Here, the prediction mode of a representative block may be the same as that of the current block.

As another embodiment, information indicating a method for selecting a representative block may be signaled from the video encoding apparatus to the video decoding apparatus. After selecting a representative block using the indicated selection method, the video decoding apparatus may derive representative block information.

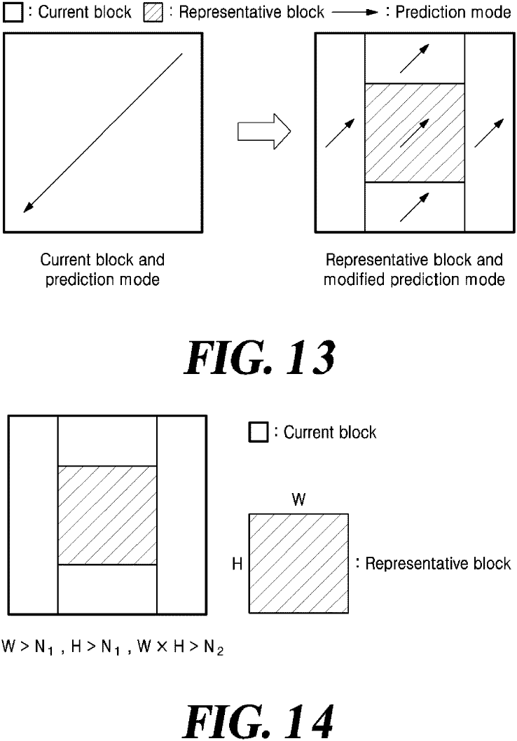

FIG. 13 illustrates selecting a representative block and modifying a prediction mode according to one embodiment of the present disclosure.

Using the representative block information, the prediction mode modifier 910 modifies the prediction modes of the representative block and the remaining subblocks according to the modifying method as described above. The video decoding apparatus may decode all subblocks in the modified prediction mode. Here, the information of the representative block used by the prediction mode modifier 910 and the modifying method according to the information are as follows.

In the following description, an embodiment in which the prediction mode modifier 910 uses the representative block size as the information of the representative block is described.

In some situations, a subblock’s size, height, or width may be reduced significantly. In this case, application of the current technique, which employs various directions for intra prediction mode, may result in suboptimal coding efficiency. Accordingly, the prediction mode modifier 910 may modify the intra prediction mode based on at least one or more conditions among a block’s size, height, and width. In other words, the prediction mode modifier 910 modifies a prediction mode when the block size corresponds to a specific condition, thereby preventing the coding efficiency from deteriorating unnecessarily.

In the following description, a specific condition on the size is described with reference to the example of FIG. 14.

The prediction mode modifier 910 may modify the prediction mode when the height or width of a representative block is greater than N1. Here, N1 may be 1, 2, 4, 8, 16, 32, 64, or 128, depending on the implementation.

The prediction mode modifier 910 may modify the prediction mode when the size of a representative block is larger than N2. Here, N2 may be 1, 2, 4, 8, 16, 32, 64, 128, 256, 512, or 1024, depending on the implementation. Also, the size of a block may be calculated as the product of the block’s height and width.

When the specific condition described above is met, the prediction mode modifier 910 may modify the prediction modes of subblocks to an intra prediction mode different from the intra prediction mode of the current block. Here, the prediction mode modifier 910 may use the modifying method described above.

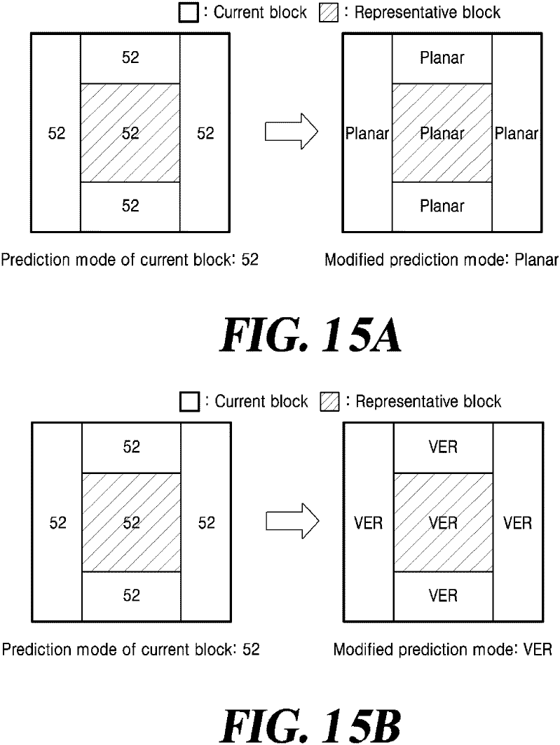

For example, it is assumed that the prediction mode of a current block is 52, and the current block is subpartitioned, as shown in FIG. 15A. In this case, the video decoding apparatus may modify the prediction direction according to a condition after setting the representative block as shown in FIG. 15A. If the representative block size is larger than N2, the prediction mode modifier 910 may divide the prediction mode into a non-directional mode group and a directional mode group as shown in FIG. 15A and then modify the prediction modes of the representative block and the remaining subblocks to the Planar mode included in the non-directional mode group. The video decoding apparatus may perform intra prediction of subblocks using the modified prediction mode.

As another example, as shown in FIG. 15B, when the preset mode is selected in the vertical direction (VER), the prediction mode modifier 910 may modify the prediction modes of the representative block and the remaining subblocks in the vertical direction. Alternatively, the prediction mode modifier 910 may modify the prediction modes of the representative block and the remaining subblocks to the VER mode obtained by rotating the prediction mode of a current block by S. Like the two examples according to the illustration of FIG. 15B, the prediction mode modifier 910 may derive the same result regardless of variations in the implementation.

In the following description, an embodiment in which the prediction mode modifier 910 uses the representative block shape as the information of the representative block is described.

The shape of a subpartitioned subblock may be different from that of a current block. Accordingly, the coding efficiency may vary when a prediction mode signaled for a current block is applied to the current block and subblocks. This problem occurs more severely when the WAIP technique is used; whether restored reference pixels are available or existing reference pixels are used may significantly affect coding efficiency. Therefore, the prediction mode modifier 910 may modify the prediction modes of the representative block and the remaining subblocks according to the shape of the representative block, and the video decoding apparatus may perform intra prediction of the representative block and the remaining subblocks using the modified prediction mode.

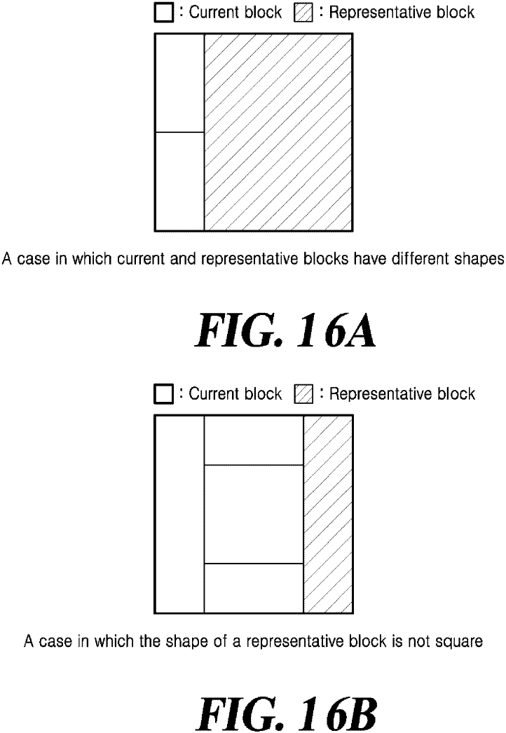

In the following description, with reference to the examples of FIGS. 16A and 16B, a condition for determining whether modification is needed is described.

FIGS. 16A and 16B illustrate a condition for modifying a prediction mode of a subblock based on the shape of a representative block according to one embodiment of the present disclosure.

The prediction mode modifier 910 may modify the prediction modes of subblocks when the shape of a representative block is different from that of the current block, as shown in FIG. 16A.

The prediction mode modifier 910 may modify the prediction modes of subblocks when the shape of the representative block is not square, as shown in FIG. 16B.

When the modifying condition is satisfied, the prediction mode modifier 910 may modify the prediction modes of subblocks to an intra prediction mode having a value different from that of the current block. Here, the prediction mode modifier 910 may use the modifying method described above.

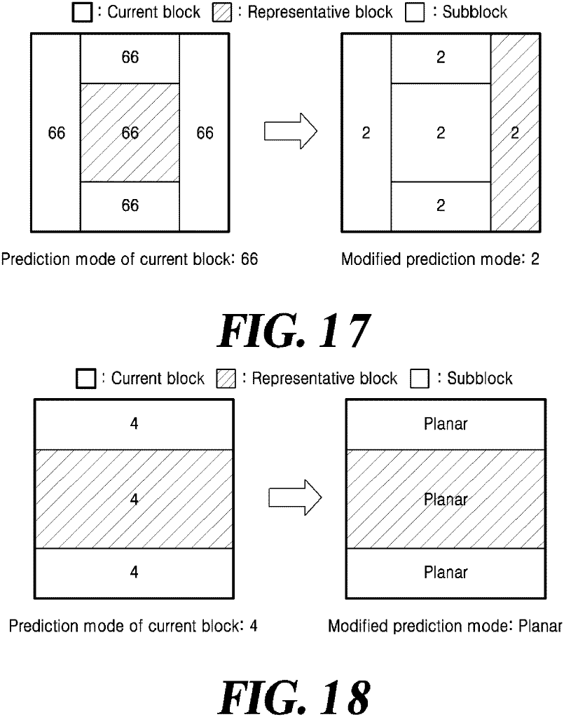

For example, it is assumed that the prediction mode of a current block is 66, and the current block is subpartitioned as shown in FIG. 17. At this time, the video decoding apparatus may modify the prediction direction according to a condition after setting the representative block as in the example of FIG. 17. Since the example of FIG. 17 satisfies the condition that the shape of the representative block is not square, which is a modifying condition according to the example of FIG. 16B, the prediction mode modifier 910 may modify the intra prediction mode. The prediction mode modifier 910 may rotate the prediction direction, which is one of the methods for modifying a prediction mode described above, by 180 degrees and set the prediction modes of the representative block and the remaining subblocks to prediction mode 2, as shown in the example of FIG. 17. The video decoding apparatus may perform intra prediction of the representative block and the remaining subblocks using the modified prediction mode.

Meanwhile, to quantify the shape of a block (or subblock), the prediction mode modifier 910 may use the block (or subblock) aspect ratio.

In the following description, an embodiment in which the prediction mode modifier 910 uses the position of a representative block as information of the representative block is described.

When subpartitioned subblocks are reconstructed in sequential order, subblocks reconstructed later may refer to pixel values of newly reconstructed subblocks. In this case, coding efficiency may be further improved by using pixel values closer or more similar to the original pixel values as reference pixels. Therefore, during reconstruction according to intra prediction, if newly reconstructed pixel values are unavailable because the representative block is located at a specific position, the prediction mode modifier 910 may modify the prediction modes of subblocks using the same method as the modifying method above.

Meanwhile, the specific position may be the center, top, bottom, right, left, top left, top right, bottom left, or bottom right of the current block.

For example, as shown in FIG. 18, when a representative block is located at the center of the current block, which corresponds to a specific position, the prediction mode modifier 910 may modify the prediction modes of the representative block and the remaining subblocks to the non-directional mode, which is one of the modifying methods described above, namely, the planar mode.

In the following description, an embodiment in which the prediction mode modifier 910 uses the prediction mode of a representative block as the information of the representative block is described. As described above, the prediction mode of the representative block transmitted from the video encoding apparatus may be the same as that of the current block.

When subpartitioned subblocks are reconstructed in sequential order, subblocks reconstructed later may refer to pixel values of newly reconstructed subblocks. In this case, coding efficiency may be further improved by using pixel values closer or more similar to the original pixel values as reference pixels. Therefore, during reconstruction according to intra prediction, if the representative block does not use newly reconstructed pixel values, the prediction mode modifier 910 may modify the prediction modes of subblocks using the same method as the modifying method above.

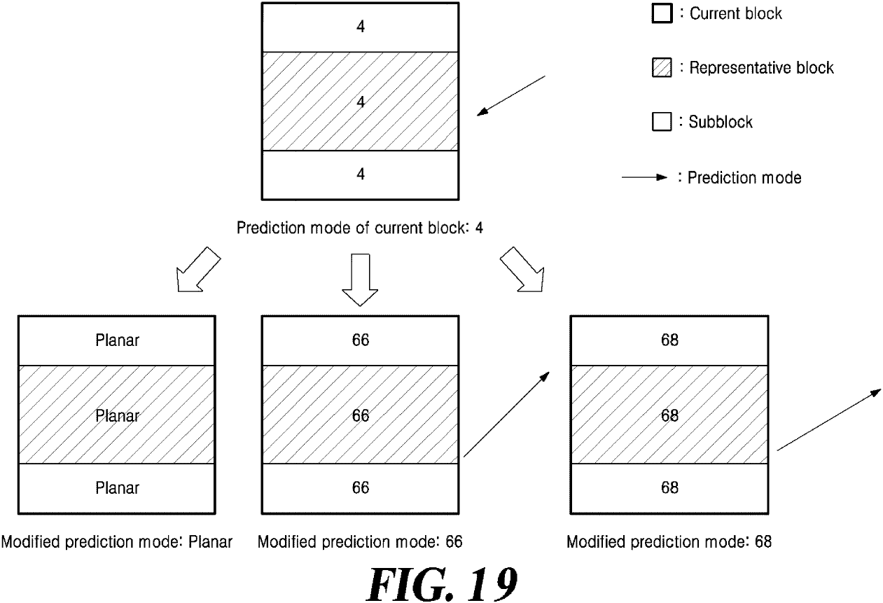

For example, it is assumed that the intra prediction mode of a current block is 4, and the current block is subpartitioned as shown in FIG. 19. At this time, each subblock does not use newly reconstructed pixel values. Accordingly, the prediction mode modifier 910 may modify the prediction modes of the subblocks using the modifying method described above. As shown in the example of FIG. 19, the prediction mode modifier 910 may modify the prediction modes of the representative block and the remaining subblocks to a non-directional mode (i.e., planar mode), a specific directional mode (i.e., mode 66) or a directional mode rotated by 180 degrees (i.e., mode 68).

As another embodiment, a different modified prediction mode may be generated for each subblock.

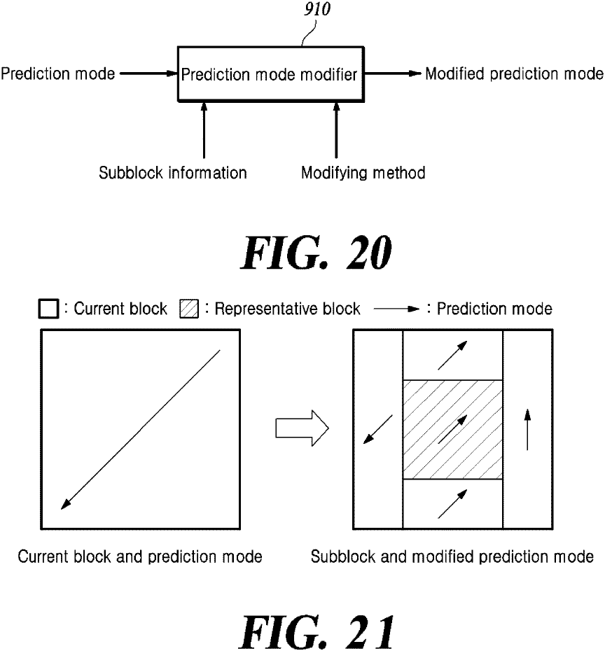

FIG. 20 conceptually illustrates a prediction mode modifier according to another embodiment of the present disclosure.

The prediction mode modifier 910 according to another embodiment modifies the prediction mode of a current block using subblock information and a modifying method and thus may generate a modified prediction mode for each subblock. In other words, in the examples of FIGS. 9 and 11, intra prediction modes are modified so that all subblocks included in a current block use the same prediction mode. However, as illustrated in FIG. 21, the prediction mode modifier 910 according to the present embodiment may modify intra prediction modes to be different for the respective subblocks.

When the present embodiment is applied, since each subblock uses a different prediction mode, the video decoding apparatus may adaptively select and apply a filter to the boundary of each subblock.

Meanwhile, the prediction mode modifier 910 may adaptively modify the prediction mode for each subblock using only one prediction mode without necessarily signaling each subblock. At this time, the prediction mode modifier 910 may use the method for modifying the prediction mode described above.

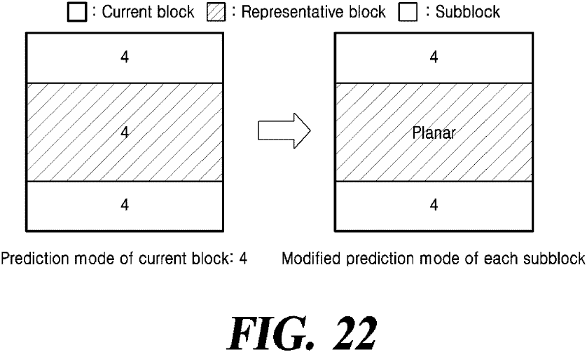

For example, it is assumed that the intra prediction mode of a current block is 4, and the current block is subpartitioned as shown in FIG. 22. The prediction mode modifier 910 may derive the result as shown in the example of FIG. 22 using the method for modifying the prediction mode for each subblock. The condition for modifying a prediction mode used by the prediction mode modifier 910 is satisfied when the height of a block is greater than N1, and the adopted modifying method modifies a prediction mode to the planar mode, which is a non-directional mode.

Meanwhile, whether to use a modified prediction mode for each subblock may be determined according to a prior agreement between the video encoding apparatus and the video decoding apparatus. Alternatively, the video encoding apparatus may transmit a flag indicating whether to use a modified prediction mode for each subblock to the video decoding apparatus.

In the following description, an embodiment in which prediction modes of subblocks are modified using a preset pattern according to a preset order is described.

As another embodiment, after setting a pattern in advance to be used for modifying a prediction mode, the prediction mode modifier 910 may modify the prediction modes of subblocks using the preset pattern. Here, a preset pattern that may be used is as follows.

For example, the prediction mode modifier 910 may use a pattern such as increasing or decreasing a prediction mode by a change amount according to a preset order. Here, the change amount may be 1, 2, 3, 4, 5, 6, 7, 8, 9, 10, 11, 12, 13, 14, 15, and so on. Also, whether a prediction mode increases or decreases within the pattern may be set in advance or signaled.

The change amount for the pattern above may be set in advance between the video encoding apparatus and the video decoding apparatus. As another example, the video decoding apparatus may derive the change amount by referring to subblock information, subpartitioning information related to the example of FIG. 8, or representative block information. Here, the subpartitioning information is related to the example of FIG. 8, the subblock information is related to the example of FIG. 9, and the representative block information is related to the example of FIG. 11.

Meanwhile, whether to use a preset pattern may be determined according to a prior agreement between the video encoding apparatus and the video decoding apparatus. Alternatively, the video encoding apparatus may transmit a flag indicating whether to use a preset pattern to the video decoding apparatus.

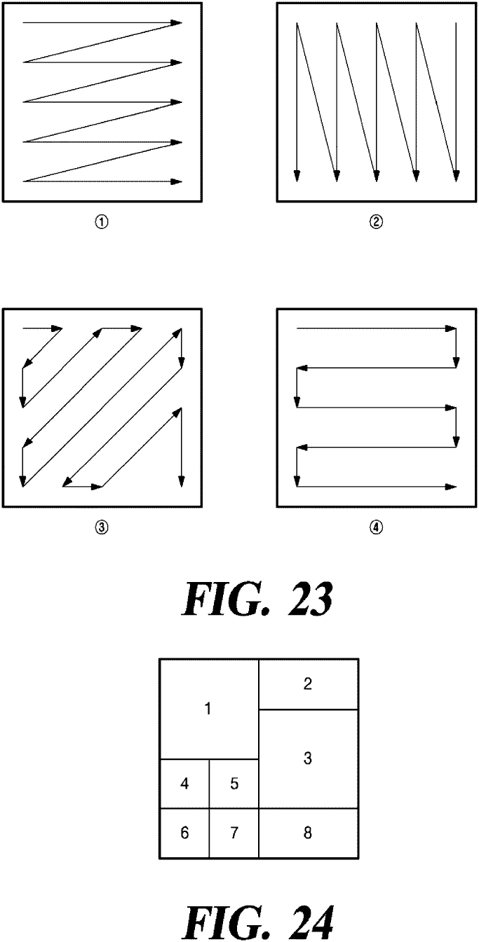

Meanwhile, the preset order refers to the order of encoding (or decoding) subblocks within a current block and may be set as one of the examples of FIG. 23.

For example, when the preset order is the same as ① illustrated in FIG. 23, the prediction mode modifier 910 may select a prediction mode modification order for subblocks as in the example of FIG. 24.

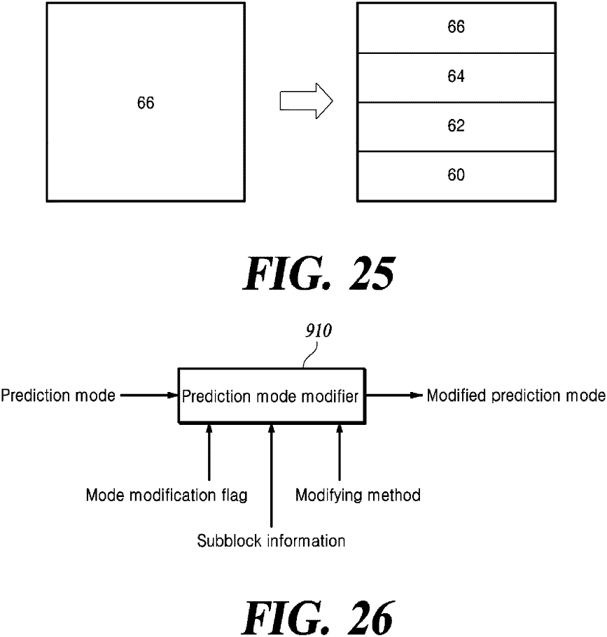

In another example, it is assumed that the intra prediction mode of a current block is 66, and the current block is split into four subblocks as shown in FIG. 25. As shown in FIG. 25, the prediction mode modifier 910 may modify the prediction mode to start from 66 and decrease by 2.

In yet another example, a prediction mode modification flag may be used to modify the prediction modes of subblocks.

FIG. 26 conceptually illustrates a prediction mode modifier according to yet another embodiment of the present disclosure.

The prediction mode modifier 910 according to another embodiment may modify the prediction mode of a subblock by selectively applying one of the above implementations based on the prediction mode modification flag. The video encoding apparatus may indicate information on how to modify the prediction mode for all or each subblock by transmitting a mode modification flag (in the following description, the mode modification flag is denoted as ‘sub_pred_mode_flag’) as shown in FIG. 26 to the video decoding apparatus.

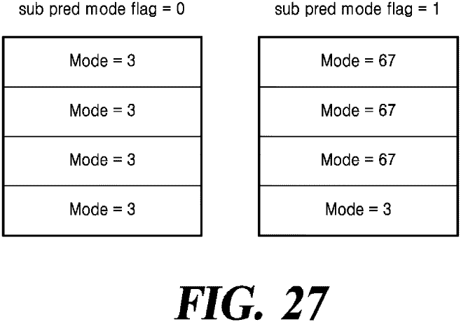

As in the example of FIG. 27, when sub_pred_mode_flag is 0, the existing ISP technique is used. When sub_pred_mode_flag is 1, the prediction mode modifier 910 may perform a preset implementation. Here, one of several implementation examples described above may be designated as the preset implementation according to a prior agreement between the video encoding apparatus and the video decoding apparatus. In the example of FIG. 27, the preset implementation example generates a modified prediction mode for each subblock.

Meanwhile, the description above relates to a method of modifying the prediction mode of a subblock in the intra predictor 542 of the video decoding apparatus. However, the same description may be applied to the intra predictor 122 of the video encoding apparatus. In other words, to modify the prediction mode of a subblock, the intra predictor 122 may also include a prediction mode modifier.

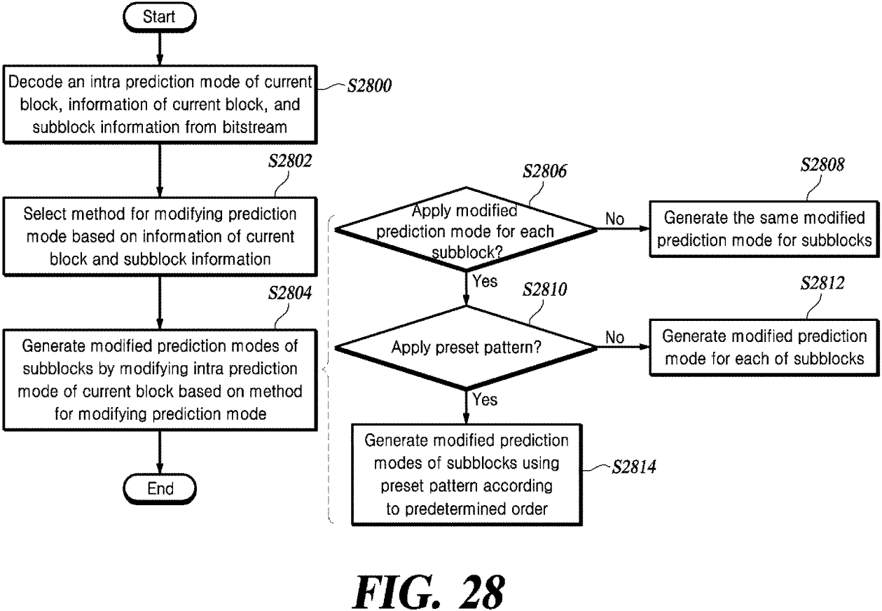

In the following description, with reference to FIG. 28, a method for modifying prediction modes of subblocks by the video decoding apparatus based on subblock information is described.

FIG. 28 is a flow diagram illustrating a method of modifying prediction modes of subblocks performed by the video decoding apparatus according to one embodiment of the present disclosure.

The entropy decoder 510 within the video decoding apparatus decodes the intra prediction mode of a current block, information of the current block, and subblock information from a bitstream (S2800). Here, the subblock information provides information related to subblocks obtained by partitioning the current block.

The subblock information may include all or part of the information on the sizes, widths, heights, aspect ratios, splitting directions, and the number of subblocks.

The information on the current block may include all or part of information on the size, width, height, and aspect ratio of the current block.

The intra predictor 542 within the video decoding apparatus selects a method for modifying a prediction mode based on the information of the current block and subblock information (S2802).

The intra predictor 542 may select a method for modifying a prediction mode as follows.

The intra predictor 542 may use a method of rotating the intra prediction mode of a current block by a specific angle S.

Alternatively, the intra predictor 542 may set the modified prediction mode to a specific mode X. The specific mode X may be one of prediction modes grouped according to a predetermined criterion or may be a predetermined mode.

Here, the predetermined criterion for grouping prediction modes may be one of a vertical group, a horizontal group, a diagonal group, a diagonal direction of the current block, a diagonal direction of subblocks, a directional mode group, a non-directional mode group, a prediction mode group calculated from machine learning, or a combination of some of the above.

Also, the predetermined mode may be specified as one of the Planar mode, the DC mode, a diagonal directional mode of subblocks, a diagonal directional mode of a current block, a mode calculated by machine learning, a vertical mode, a horizontal mode, or a diagonal directional mode.

The intra predictor 542 modifies the intra prediction mode of a current block based on the method of modifying a prediction mode to generate modified prediction modes of subblocks (S2804).

In the following description, the S2806 to S2814 steps corresponding to generating a modified prediction mode S2804 is described in detail.

The intra predictor 542 checks whether a modified prediction mode is applied for each subblock according to a prior appointment (S2806). When a modified prediction mode is not applied for each subblock (No in S2806), the intra predictor 542 generates the same modified prediction mode for the subblocks (S2808).

When a modified prediction mode is applied for each subblock (Yes in S2806), the intra predictor 542 checks whether a preset pattern according to a prior appointment is applied (S2810). When the preset pattern is not applied (No in S2810), the intra predictor 542 generates a modified prediction mode for each of the subblocks (S2812).

When a preset pattern is applied (Yes in S2810), the intra predictor 542 generates modified prediction modes of subblocks using the preset pattern according to a predetermined order (S2814).

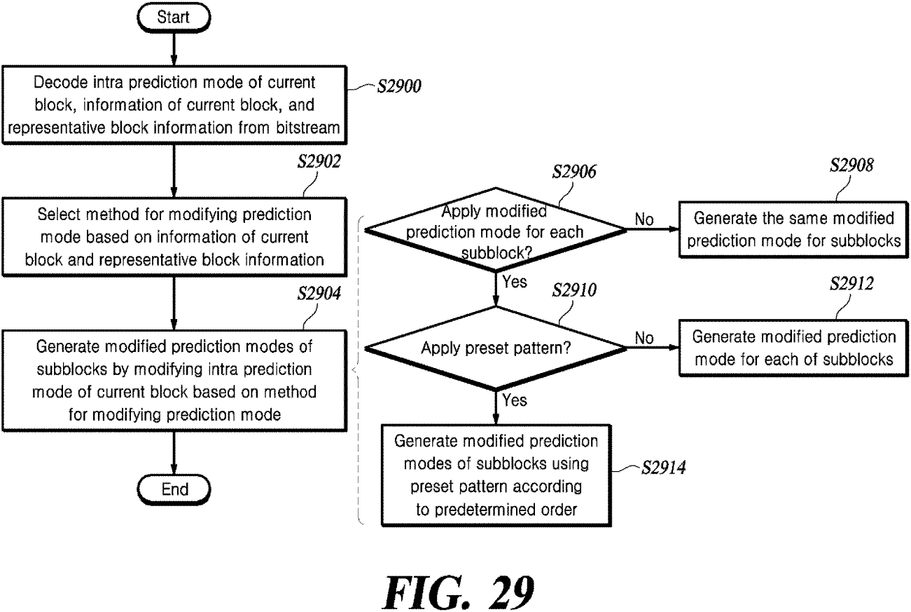

In the following description, with reference to FIG. 29, a method for modifying prediction modes of subblocks by the video decoding apparatus based on representative block information is described.

FIG. 29 is a flow diagram illustrating a method for modifying prediction modes of subblocks performed by a video decoding apparatus according to another embodiment of the present disclosure.

The entropy decoder 510 within the video decoding apparatus decodes the intra prediction mode of a current block, information on the current block, and representative block information from a bitstream (S2900). Meanwhile, a representative block is a block selected from among subblocks and may be selected by the video encoding apparatus according to representative block selection methods.

The representative block information may describe the characteristics of a representative block, including at least one of the representative block’s position, size, width, height, or shape (or aspect ratio).

The intra predictor 542 within the video decoding apparatus selects a method for modifying a prediction mode based on the information of a current block and representative block information (S2902).

When the representative block size satisfies a specific condition, the intra predictor 542 may select the method for modifying the prediction mode described above. Here, the specific condition may be satisfied when the height or width of the representative block is greater than N1 or the size of the representative block is greater than N2.

The intra predictor 542 may select a method for modifying a prediction mode according to the shape of the representative block. For example, the intra predictor 542 may select a method for modifying a prediction mode when the shape of the representative block is different from that of the current block or is not square.

The intra predictor 542 may select a method for modifying a prediction mode according to the position of a representative block. At the time of reconstruction according to intra prediction, when newly reconstructed pixel values are unavailable because a representative block is located at a specific position, the intra predictor 542 may select a method for modifying a prediction mode. Here, the specific position may be the center, top, bottom, right, left, top left, top right, bottom left, or bottom right of the current block.

The intra predictor 542 may select a method for modifying a prediction mode according to the prediction mode of the representative block. At the time of reconstruction according to intra prediction, when the representative block does not use newly reconstructed pixel values, the intra predictor 542 may select a method for modifying a prediction mode.

The intra predictor 542 modifies the intra prediction mode of a current block based on the method of modifying a prediction mode to generate modified prediction modes of subblocks (S2904).

Since the steps corresponding to the step of generating a modified prediction mode (S2904) are the same as the S2806 to S2814 steps according to FIG. 28, further descriptions is omitted.

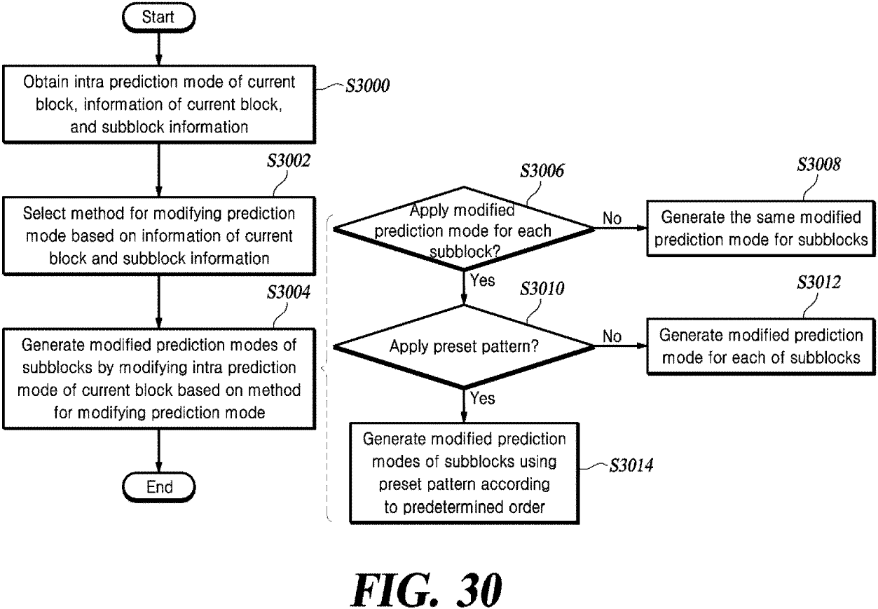

In the following description, with reference to FIG. 30, a method for modifying prediction modes of subblocks by the video encoding apparatus based on subblock information is described.

FIG. 30 is a flow diagram illustrating a method for modifying prediction modes of subblocks performed by a video encoding apparatus according to one embodiment of the present disclosure.

As described above, the method for modifying prediction modes of subblocks according to the present embodiment may also be performed by the intra predictor 122 of the video encoding apparatus for bit rate distortion analysis. In this case, during the bit rate distortion analysis process, the video encoding apparatus searches for an optimal intra prediction mode of the current block, current block information, and subblock information. During the search process, the intra predictor 122 obtains the intra prediction mode of the current block, current block information, and subblock information (S3000).

In the illustration of FIG. 30, the steps of selecting a method for modifying a prediction mode (S3002) and generating a modified prediction mode (S3004) perform the same operations as the corresponding steps in the FIG. 28. Therefore, descriptions of the overlapping steps is omitted.

The video encoding apparatus may encode an optimal intra prediction mode of the current block according to the bit rate distortion analysis, current block information, and subblock information and then transmit the encoded information to the video decoding apparatus.

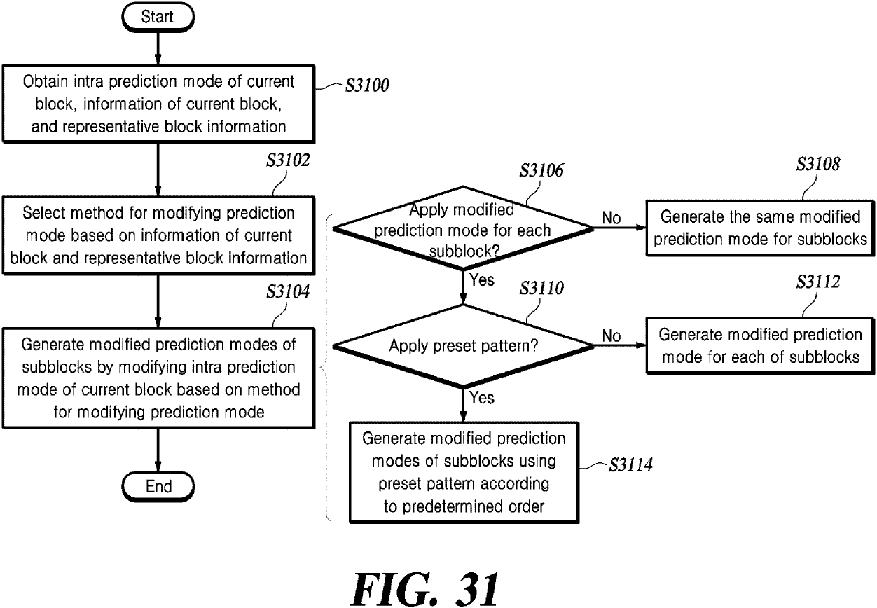

In the following description, with reference to FIG. 31, a method for modifying prediction modes of subblocks by the video encoding apparatus based on representative block information is described.

FIG. 31 is a flow diagram illustrating a method for modifying prediction modes of subblocks performed by a video encoding apparatus according to another embodiment of the present disclosure.

During the bit rate distortion analysis process, the video encoding apparatus searches for an optimal intra prediction mode of the current block, current block information, and subblock information. During the search process, the intra predictor 122 obtains the intra prediction mode of the current block, current block information, and subblock information (S3100).

In the illustration of FIG. 31, the steps of selecting a method for modifying a prediction mode (S3102) and generating a modified prediction mode (S3104) perform the same operations as the corresponding steps in the FIG. 29. Therefore, descriptions of the overlapping steps is omitted.

The video encoding apparatus may encode an optimal intra prediction mode of the current block according to the bit rate distortion analysis, current block information, and subblock information and then transmit the encoded information to the video decoding apparatus.

Although the steps in the respective flowcharts are described to be sequentially performed, the steps merely instantiate the technical idea of some embodiments of the present disclosure. Therefore, a person having ordinary skill in the pertinent art could perform the steps by changing the sequences described in the respective drawings or by performing two or more of the steps in parallel. Hence the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “... unit” to strongly emphasize the possibility of their independent realization.

Meanwhile, various methods or functions described in some embodiments may be implemented as instructions stored in a non-transitory recording medium that can be read and executed by one or more processors. The non-transitory recording medium includes, for example, all types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, one of ordinary skill should understand the scope of the present disclosure is not to be limited by the above explicitly described embodiments but by the claims and equivalents thereof.

### REFERENCE NUMERALS

122: intra predictor
510: entropy decoder
542: intra predictor
910: prediction mode modifier

What is claimed is:

1. An intra prediction method for generating modified prediction modes of subblocks performed by a video decoding apparatus, the method comprising:
decoding an intra prediction mode of a current block, information of the current block, and subblock information from a bitstream, wherein the subblock information provides information related to the subblocks obtained by partitioning the current block;
selecting a method for modifying a prediction mode based on the information of the current block and the subblock information; and
generating the modified prediction modes by modifying the intra prediction mode of the current block based on the method for modifying the prediction mode.

2. The method of claim 1, wherein the subblock information includes all or part of the information on sizes, widths, heights, aspect ratios, splitting directions, or the number of the subblocks.

3. The method of claim 1, wherein the information of the current block includes all or part of the information on size, width, height, or aspect ratio of the current block.

4. The method of claim 1, wherein the method for modifying the prediction mode rotates the intra prediction mode of the current block by a specific angle S.

5. The method of claim 1, wherein the method for modifying the prediction mode sets the modified prediction mode to a specific mode, wherein the specific mode is one of prediction modes grouped according to a predetermined criterion, or a predetermined mode.

6. The method of claim 5, wherein the predetermined criterion is one of a vertical group, a horizontal group, a diagonal group, a diagonal direction of the current block, a diagonal direction of the subblocks, a directional mode group, a non-directional mode group, a prediction mode group calculated from machine learning, or a combination of some of the above.

7. The method of claim 5, wherein the predetermined mode is one of the Planar mode, the DC mode, a diagonal directional mode of the subblocks, a diagonal directional mode of the current block, a mode calculated by machine learning, a vertical mode, a horizontal mode, or a diagonal direction mode.

8. The method of claim 1, wherein the generating the modified prediction modes comprises generating the same modified prediction mode for the subblocks.

9. The method of claim 1, wherein the generating the modified prediction modes comprises generating the modified prediction mode for each of the subblocks when application of the modified prediction mode is agreed in advance for each subblock.

10. The method of claim 9, wherein the generating the modified prediction modes comprises generating a modified prediction mode of the subblocks using a preset pattern according to a predetermined order when application of the preset pattern is agreed in advance.

11. The method of claim 10, wherein the predetermined order is order of decoding subblocks within the current block.

12. An intra prediction method for generating modified prediction modes of subblocks performed by a video encoding apparatus, the method comprising:
obtaining an intra prediction mode of a current block, information of the current block, and subblock information, wherein the subblock information provides information related to the subblocks obtained by partitioning the current block;
selecting a method for modifying a prediction mode based on the information of the current block and the subblock information; and
generating the modified prediction modes by modifying the intra prediction mode of the current block based on the method for modifying the prediction mode.

13. A computer-readable recording medium storing a bitstream generated by a video encoding method for generating modified prediction modes of subblocks, wherein the method comprising:
obtaining an intra prediction mode of a current block, information of the current block, and subblock information, wherein the subblock information provides information related to the subblocks obtained by partitioning the current block;
selecting a method for modifying a prediction mode based on the information of the current block and the subblock information; and
generating the modified prediction modes by modifying the intra prediction mode of the current block based on the method for modifying the prediction mode.
